(19) United States
(12) Patent Application Publication
(10) Pub. No.: US 2016/0143715 A1
(43) Pub. Date: May 26, 2016

(54) DENTAL IMPRESSION TRAY

(71) Applicant: Nam Gyu KIM, Jeollanam-do (KR)

(72) Inventor: Nam Gyu KIM, Jeollanam-do (KR)

(21) Appl. No.: 14/898,486

(22) PCT Filed: Apr. 15, 2014
(86) PCT No.: PCT/KR2014/003223

§ 371 Date: Dec. 15, 2015

(30) Foreign Application Priority Data
Jul. 10, 2013 (KR) 10-2013-0080861

(51) Int. Cl. A61C 9/00

(52) U.S. Cl. CPC A61C 9/0006

(57) ABSTRACT

A dental impression tray comprises: a handle; and an impression-taking frame provided at one side of the handle to support an impression material from a lateral side, wherein the impression-taking frame is formed as a right and left pair, a plurality of vertical taking grooves are formed at predetermined intervals on the inner lateral side thereof, and a taking groove positioned on the left side and a taking groove positioned on the right side are provided so as to have a gradient of 10 degrees and 5 degrees, respectively.

### BACKGROUND

The present invention relates to a dental impression tray, and in particular to a dental impression tray wherein an impression taking can be accurately and easily carried out by an impression taker in such a way to provide different left and right angles at an impression-taking frame in accordance with a tooth inclination.

It needs to take an impression of a tooth from a patient so as to manufacture a prosthetic appliance of a dental patient. A device for simultaneously taking the impressions of upper and lower jaw teeth during the above procedure is called an impression tray or a bite tray.

The configuration of a conventional dental impression tray is formed of a concave structure to receive impression materials, of which the left and right sides are shaped identical, and a handle fixed at the above structure. The method for manufacturing a dental impression tray may be formed of a blow molding, an injection molding, a compression molding and a vacuum molding. At most of the dental hospitals in advanced countries and Korea, a disposable type impression tray is used when taking a tooth impression for the sake of sanitation and convenience. The above disposable type impression tray is made of a polypropylene, ABS material, etc. which is a kind of plastic resin since it is cheap and easy to manufacture thanks to the nature of a disposable type.

The plastic impression tray and a common plastic bite tray into each of which a conventional reinforcing material is inserted have the following disadvantages.

In the bite tray of which the left and right sides are shaped identical and into which a metallic reinforcing material is inserted, an impression-taking film is arranged tight, so any strain may occur on an engaging surface during a bite impression of a corresponding tooth, which may make hard to manufacture a dental prosthetic appliance.

In the plastic impression tray or common plastic impression tray of which the left and right sides are shaped identical and into which a metallic reinforcing material is inserted, an impression-taking frame won't transform freely, so it is impossible to take an impression from a dental patient who has a non-uniform dentition or a bent arch. For this reason, an impression may be taken only from a lateral side using a common omni-tray. This method is possible to simultaneously take the impressions of the upper and low jaw teeth and is very standardized, whereby it is hard to take a tooth impression in an enough and appropriate way.

In order to improve the above mentioned problems, as illustrated in FIG. 2, there is provided a tray for taking a plastic tooth impression which includes a handle which an impression taker holds with hands, and an impression-taking frame is provided at the side of the handle and at the opposite side thereof so as to support the impression from its side surface, and a reinforcing member, which is a reinforcing member, is fixedly inserted in an exposed shape toward the outside at a predetermined outer portion of a connection ring to which both the impression frames are connected, and an impression-taking film is included, which provides a concave space formed in the center so as to store an impression material used to take an impression. In the tray for taking a tooth impression, an impression may be taken in such a way to bending a little to match with a curved degree of a dentition by partially transforming the exterior of a tooth impression-taking bite tray after dividing each wall of the upper, lower, left and right surfaces of an impression-taking frame into multiple spaces at regular intervals.

In the above tooth impression-taking tray, an exterior of a tray may be partially transformed, but it is hard to provide an anatomical configuration accurately matching at left, right, front and rear sides with the shape of each tooth.

In the tooth impression-taking tray of which the left and right sides are shaped identical, the wall of the impression-taking frame is formed vertical. Our teeth normally have inclinations in teeth. The above tray has a configuration which is opposite to the structure of our teeth formed of steps due to upper and lower jaw teeth. Since the impression is taken using the tray of which the left and right sides are shaped identical, the impression taking may be accurately carried out by the impression taker.

Our teeth, in general, have inclinations in the right opposite directions in the front, rear, left and right sides, which are called a spee curve (a curve shape, not a straight line, is formed between front teeth and back teeth) and a wilson curve (a curve shape, not a straight line, is formed at left side teeth and right side teeth) (refer to FIG. 1), and the upper and lower jaw teeth are stepped opposite to each other on the left and right sides.

As compared with our tooth structure wherein the left and right sides are arranged opposite to each other, the common tray of which the left and right sides are shaped identical may cause a non-uniform thickness in an impression material upon checking after the impression was taken, which may deform the model, so accuracy may be greatly lowered. (Patent document 1) Korean patent publication No. 10-2011-0032963

### SUMMARY OF THE INVENTION

Accordingly, the present invention is made in an effort to prevent any deformation of an impression material which has occurred since the left and right sides are shaped identical, and it is an object of the present invention to provide a dental impression tray of which the left and right sides can be recognized, whereupon an impression taker can accurately and easily take an impression in such a way to provide different left and right side angles at an impression-taking frame in accordance with teeth inclinations.

It is another object of the present invention to provide a dental impression tray which is able to improve the problems wherein the left and right side impressions of a patient are taken using the same tray nevertheless the left and right sides of the teeth are different and which makes it possible to accurately and easily take an impression in such a way to provide an impression tray wherein the inclinations of the left and right side taking grooves are different.

To achieve the above objects, there is provided a dental impression frame, which may include, but is not limited to, a handle; and an impression-taking frame which is provided at one side of the handle and is able to support an impression material from its side surface, wherein the impression-taking frame is provided in a pair at left and right sides, and a plurality of taking grooves are formed on its inner side surface in vertical directions at regular intervals, and the taking groove positioned at the left side in the upward direction about a central line of the impression-taking frame has an inclination angle of 10° and the taking groove positioned at the right side has an inclination angle of 5°, each in the form of inclinations.

In addition, a pair of grabbing grooves are formed on one side surface of the handle for the sake of easier grabbing.

The present invention has advantageous effects since an impression taker is able to accurately and easily take an impression in such a way to provide different left and right side angles at an impression-taking frame in accordance with the inclinations of teeth.

### BRIEF DESCRIPTION OF DRAWINGS

FIG. 1 is a reference view illustrating an arrangement of teeth.

FIG. 2 is a perspective view illustrating an example of a conventional tooth impression-taking tray.

FIG. 3 is a perspective view illustrating another example of a conventional tooth impression-taking tray.

FIG. 4 is a perspective view illustrating a dental impression tray according to the present invention.

FIG. 5 is a front view illustrating a dental impression tray according to the present invention.

FIG. 6 is a photo obtained by photographing one side of an actual product of a dental impression tray according to the present invention.

FIG. 7 is a photo obtained by photographing the other side of an actual product of a dental impression tray according to the present invention.

FIGS. 8 and 9 are reference views illustrating the inclinations of teeth.

### DETAILED DESCRIPTION OF THE INVENTION

The present invention to achieve the above objects and effects will be described in detail by way of the exemplary embodiments.

The dental impression tray 100 according to the present invention may include, but is not limited to, a handle 110; and an impression-taking frame 120 which is provided at one side of the handle 110 and is able to support an impression material from its side surface, wherein the impression-taking frame 120 is provided in a pair at left and right sides, and a plurality of taking grooves 121 and 122 are formed on its inner side surface in vertical directions at regular intervals, and the taking groove 121 positioned at the left side in the upward direction about a central line 120c of the impression-taking frame 120 has an inclination angle of 10° and the taking groove 122 positioned at the right side has an inclination angle of 5°, each in the form of inclinations (α, β).

Of course, an impression-taking film may be formed in the center of the inner side of the impression-taking frame 120 and may provide a concave space to accommodate an impression material.

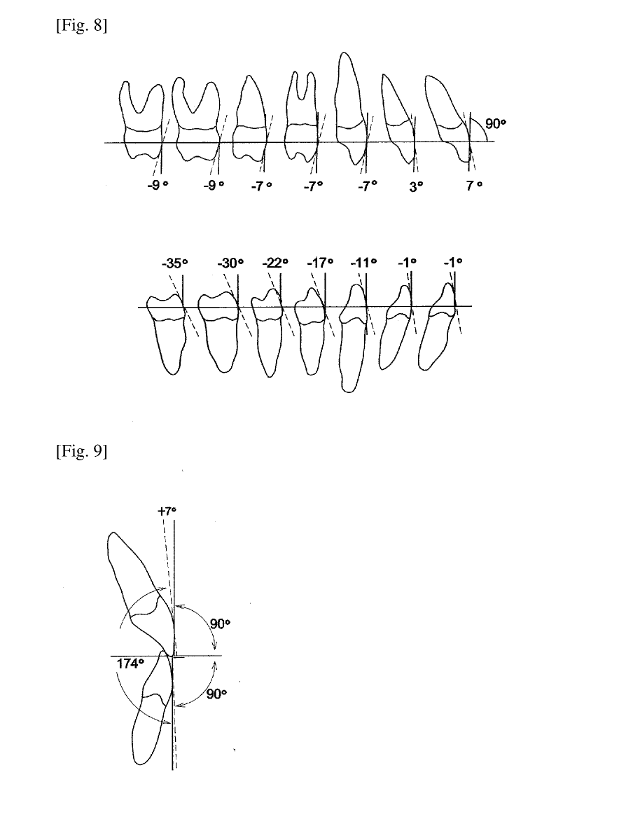

As illustrated in FIGS. 8 and 9, most of the upper jaw teeth have positive (+) inclinations, and most of the lower jaw teeth have a little bit negative (−) inclinations. As illustrated in FIG. 4, it is preferred that a taking groove 121 positioned at a left side in the taking grooves 121 has an inclination of 10°, and a taking groove 122 positioned at a right side has an inclination of 5°.

The taking grooves 121 and 122 are formed inclined leftward and rightward, and forward and backward.

As illustrated in FIG. 4, it is preferred that a pair of grabbing grooves 111 are formed on one side surface of the handle 110 for the sake of easier grabbing, so the impression taker can easily grab the handle 110.

More specifically, the above configuration is provided to make it easier to transfer the tray in such a way to prevent hands from being interfered with each other while the impression taker and an assistant person give and receive the tray, thus preventing the tray from dropping down (off the hands).

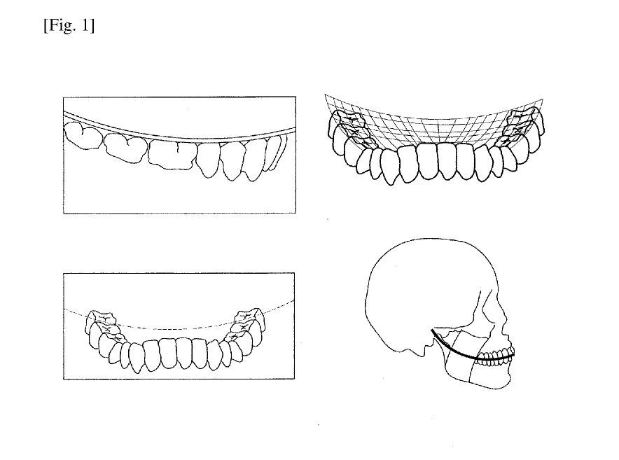

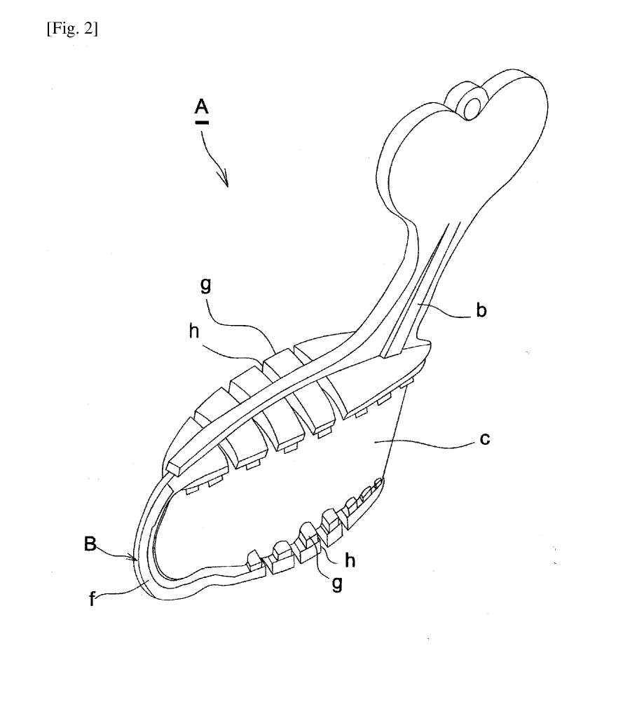

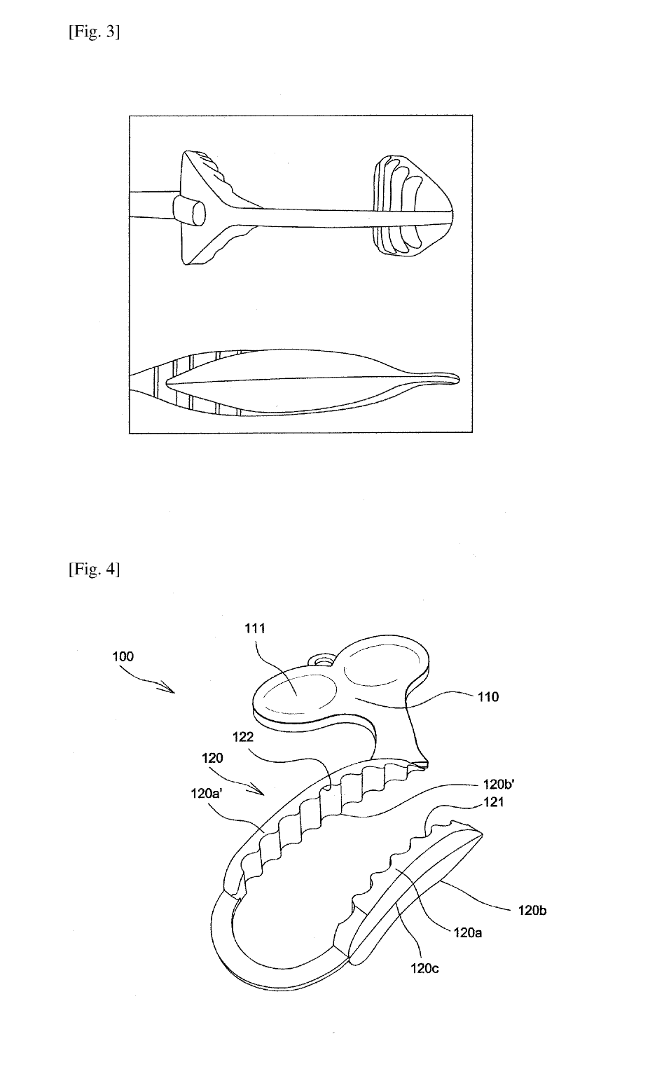

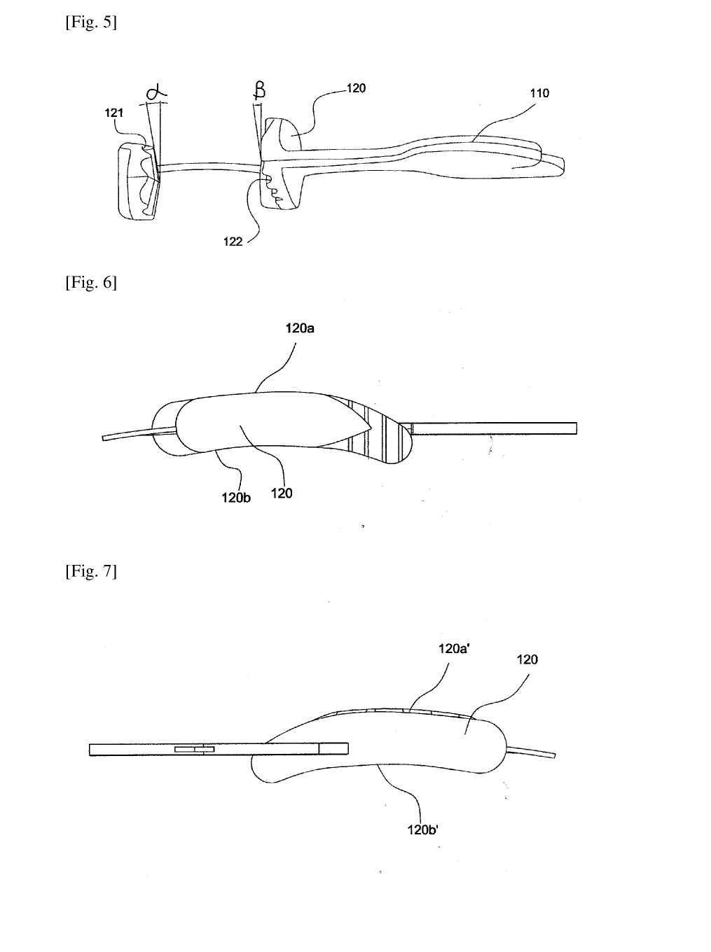

As illustrated in FIGS. 6 and 7, the upper surfaces 120a and 120a′ of the impression-taking frame 120 positioned at the left and right sides are formed inclined at predetermined inclination angles from the center to the downward direction in both directions along the curves (refer to FIG. 1) of the teeth.

It is preferred that the inclination angle of the upper surface 120a of the impression-taking frame positioned at the left side and the inclination angle of the upper surface 120a′ of the impression-taking frame positioned at the right side are different.

It is preferred that the lower surfaces 120b and 120b′ of the impression-taking frame 120 positioned at the left and right sides are formed inclined corresponding to the upper surfaces 120a and 120a′.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### DESCRIPTION OF REFERENCE NUMBERS ON THE KEY COMPONENTS IN THE DRAWINGS

100: Dental impression tray 110: Handle

111: Grabbing groove 120: Impression-taking frame

121, 122: Taking grooves

1. A dental impression frame, comprising:
a handle (110); and
an impression-taking frame (120) which is provided at one side of the handle (110) and is able to support an impression material from its side surface,
wherein the impression-taking frame (120) is provided in a pair at left and right sides, and a plurality of taking grooves (121 and 122) are formed on its inner side surface in vertical directions at regular intervals, and the taking groove (121) positioned at the left side in the upward direction about a central line (120c) of the impression-taking frame (120) has an inclination angle of 10° and the taking groove (122) positioned at the right side has an inclination angle of 5°, each in the form of inclinations (α, β).

2. The tray of claim 1, wherein the upper surfaces (120a and 120a′) of the impression-taking frame (120) positioned at the left and right sides are inclined at predetermined inclination angles from the center to the downward direction in both directions along the curve of teeth.

3. The tray of claim 1, wherein a pair of grabbing grooves (111) are formed on one side surface of the handle (110) for the sake of easier grabbing.
